(19) United States
(12) Patent Application Publication
(10) Pub. No.: US 2021/0222836 A1
(43) Pub. Date: Jul. 22, 2021

(54) LIGHT EMITTING DIODE ILLUMINATION DEVICE

(71) Applicant: MING-TSUNG CHEN, Taipei City (TW)

(72) Inventor: MING-TSUNG CHEN, Taipei City (TW)

(21) Appl. No.: 16/744,799

(22) Filed: Jan. 16, 2020

(51) Int. Cl. F21K 9/238; F21V 23/00

(52) U.S. Cl. CPC F21K 9/238; F21Y 2115/10; F21V 23/002; F21V 23/005

(57) ABSTRACT

A light emitting diode illumination device includes a control module, a signal transmitting and receiving module, and a light emitting diode module. The control module includes a first fixing unit. The first fixing unit is detachably fixed on a fixing base. The signal transmitting and receiving module is connected to the control module. The light emitting diode module includes a plurality of light emitting diode units and a substrate. The light emitting diode units are disposed on the substrate. The light emitting diode module is electrically connected to the control module. The light emitting diode module is disposed at one side of the control module.

### FIELD OF THE DISCLOSURE

The present disclosure relates to an illumination device, and more particularly to a light emitting diode illumination device.

### BACKGROUND OF THE DISCLOSURE

In general, a control signal receiving module of a light-emitting diode illumination device is disposed at an external switch of the illumination device or disposed in the illumination device. It is typically difficult to make changes to a relevant design of the illumination device.

Therefore, it is an important subject in the industry to provide a light-emitting diode illumination device with a simple design.

### SUMMARY OF THE DISCLOSURE

In response to the above-referenced technical inadequacies, the present disclosure provides a light emitting diode illumination device. The light emitting diode illumination device includes a control module, a signal transmitting and receiving module, and a light emitting diode module. The control module includes a first fixing unit. The first fixing unit is detachably fixed on a fixing base. The signal transmitting and receiving module is connected to the control module. The light emitting diode module includes a plurality of light emitting diode units and a substrate. The light emitting diode units are disposed on the substrate. The light emitting diode module is electrically connected to the control module. The light emitting diode module is disposed at one side of the control module.

Therefore, the light emitting diode illumination device provided by the present disclosure has a detachable and stackable structure. Each component of the light emitting diode illumination device is modularized, and the design of the illumination device can be easily adjusted based on a user's requirements. Therefore, an installation cost is effectively reduced.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The present disclosure will become more fully understood from the following detailed description and accompanying drawings.

FIG. 1 is an exploded view of a light emitting diode illumination device of a first embodiment of the present disclosure.

FIG. 2 is a schematic view of a connection module in FIG. 1.

FIG. 3 is another schematic view of the connection module in FIG. 1.

FIG. 4 is an exploded view of a light emitting diode illumination device of a second embodiment of the present disclosure.

FIG. 5 is a schematic view of a connection module in FIG. 4.

FIG. 6 is a schematic view of two connection units of the connection module in an unfolded state.

FIG. 7 is another schematic view of two connection units of the connection module in an unfolded state.

FIG. 8 is a schematic view of a light emitting diode illumination device of a third embodiment of the present disclosure.

FIG. 9 is a schematic view of a control module and a signal transmitting and receiving module in FIG. 8.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a”, “an”, and “the” includes plural reference, and the meaning of “in” includes “in” and “on”. Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first”, “second” or “third” can be used to describe various components, signals or the like, which are for distinguishing one component/signal from another one only, and are not intended to, nor should be construed to impose any substantive limitations on the components, signals or the like.

### First Embodiment

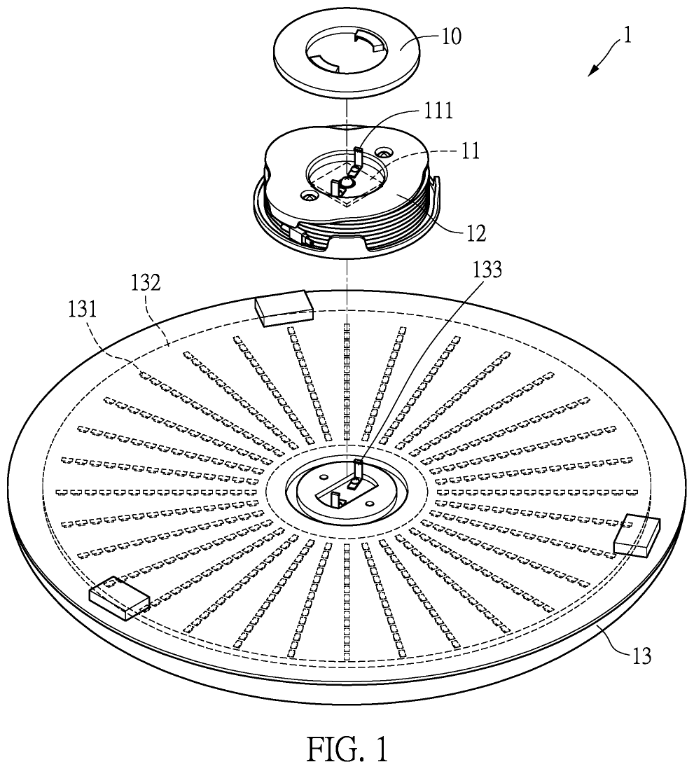

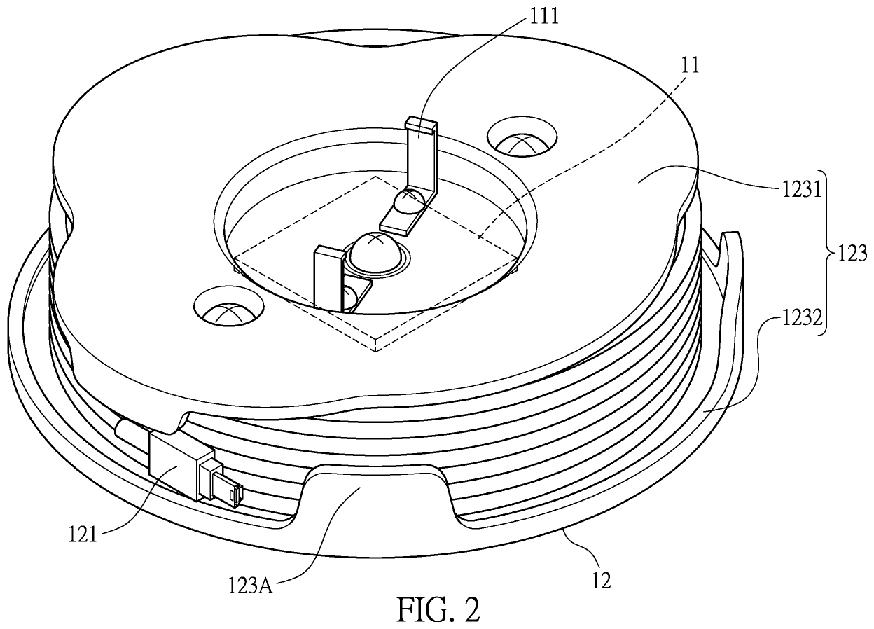

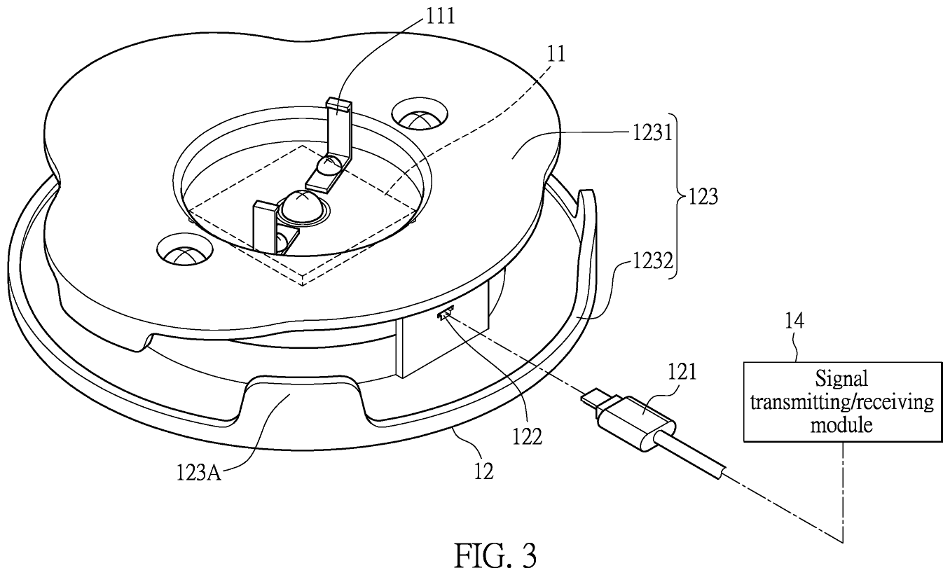

Referring to FIG. 1, FIG. 2, and FIG. 3, FIG. 1 is an exploded view of a light emitting diode illumination device of a first embodiment of the present disclosure. FIG. 2 is a schematic view of a connection module in FIG. 1. FIG. 3 is another schematic view of the connection module in FIG. 1.

A light emitting diode illumination device 1 includes a control module 11, a signal transmitting and receiving module 14, and a light emitting diode module 13. The control module 11 includes a first fixing unit 111. The control module 11 is detachably disposed on a fixing base 10 by the first fixing unit 111. The fixing base 10 is installed on a ceiling or a wall in an indoor room. The control module 11 is disposed in a housing (not shown). In the embodiment, the fixing base 10 and the housing (not shown) of the control module 11 is made of plastic, but is not limited thereto in the present disclosure.

The signal transmitting and receiving module 14 is connected to the control module 11. The control module 11 is electrically connected to a control system (not shown). In the embodiment, the signal transmitting and receiving module 14 is a Bluetooth® to serial control signal conversion module. In other words, the signal transmitting and receiving module 14 can receive a Bluetooth control signal and convert the Bluetooth control signal into a serial control signal, and the serial control signal is a wired communication signal. The signal transmitting and receiving module 14 can also convert the serial control signal transmitted from the control system (not shown) through the control module 11 into a Bluetooth signal, and the Bluetooth signal is transmitted to a mobile device (not shown) or an electronic device (not shown) for executing a control process.

The light emitting diode module 13 includes a plurality of light emitting diode units 131 and a substrate 132. The light emitting diode units 131 are disposed on the substrate 132. The light emitting diode module 13 is electrically connected to the control module 11. The control module 11 controls a turn-on state, a turn-off state, a brightness value, colors, or a lighting mode of the light emitting diode module 13 based on a lighting control signal of the control system (not shown).

In the embodiment, the light emitting diode module 13 is disposed on one side of the control module 11. Since the fixing base 10 is disposed on the ceiling, the light emitting diode module 13 is disposed below the control module 11.

Referring to FIG. 2 and FIG. 3, the connection module 12 is disposed around an exterior of the control module 11. The connection module 12 includes a connection cable 121, a connection port 122 and a receiving unit 123.

The signal transmitting and receiving module 14 is electrically connected to the control module 11 through the connection cable 121 and the connection port 122. The control module 11 provides a driving power to the signal transmitting and receiving module 14 through the connection cable 121.

The receiving unit 123 is disposed at the exterior of the control module 11. Two extension portions 1231, 1232 extend from the upper side and lower side of the housing of the control module 11. The upper extension portion 1231 includes a plurality of retaining walls 123A. The lower extension portion 1232 includes a plurality of retaining walls 123A. An accommodation space is defined by the upper extension portion 1231 of the receiving unit 123, the lower extension portions 1232 of the receiving unit 123, and the retaining walls 123A. The connection cable 121 is disposed in the accommodation space of the receiving unit 123 in a winding manner. Moreover, one end of the connection cable 121 is electrically connected to the connection port 122, and another end of the connection cable 121 is electrically connected to the signal transmitting and receiving module 14.

In the embodiment, the light emitting diode module 13 further includes a second fixing unit 133. The light emitting diode module 13 is detachably fixed on one side of the control module 11 through the second fixing unit 133. In addition, the light emitting diode illumination device 1 of the present disclosure can be connected to another light emitting diode lighting device 1 by a wired communication. In other words, the control modules of a plurality of light emitting diode illumination devices 1 can be in communication with each other by a wired communication. The light emitting diode module 13 is electrically connected to the control module 11 through the second fixing unit 133.

### Second Embodiment

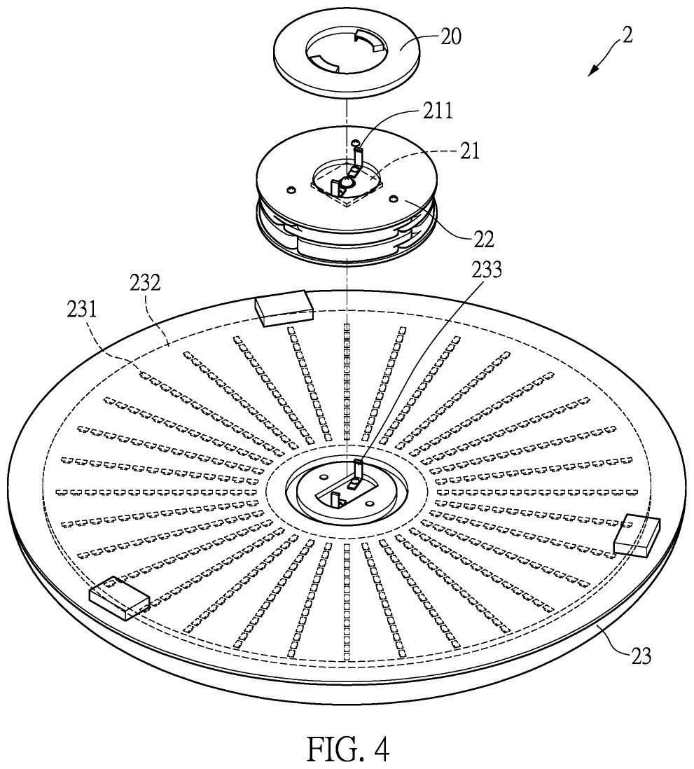

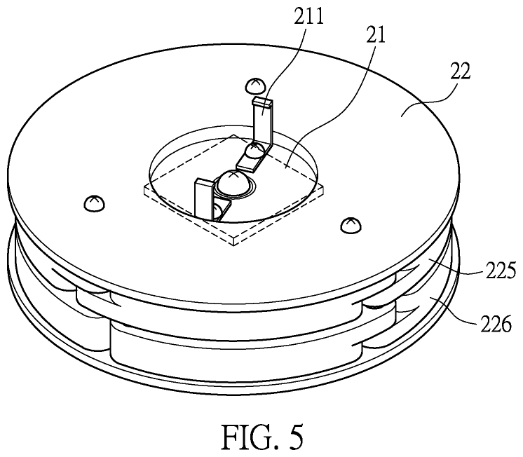

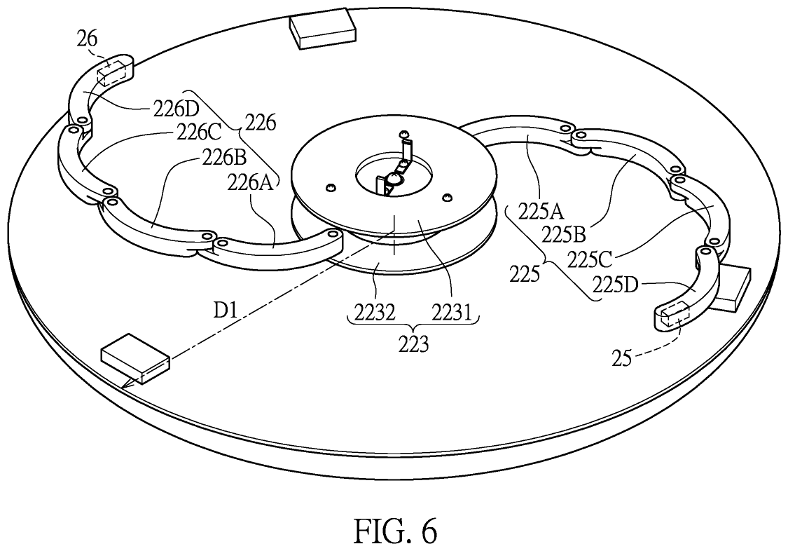

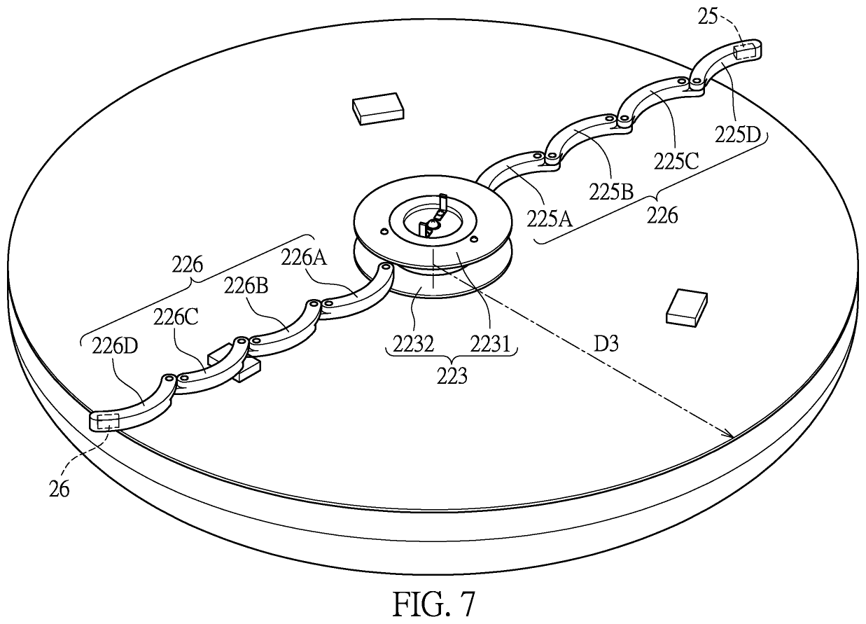

Referring to FIG. 4, FIG. 5, FIG. 6, and FIG. 7, FIG. 4 is an exploded view of a light emitting diode illumination device of a second embodiment of the present disclosure. FIG. 5 is a schematic view of a connection module in FIG. 4. FIG. 6 is a schematic view of two connection units of the connection module in an unfolded state. FIG. 7 is another schematic view of two connection units of the connection module in an unfolded state.

A light emitting diode lighting device 2 of this embodiment is similar to the light emitting diode lighting device 1 of the first embodiment. The greatest difference therebetween is that a design of a connection module 22 is different from that of the connection module 12 of the first embodiment. In addition, the light emitting diode lighting device 2 includes two signal transmitting and receiving modules 25, 26.

A light emitting diode illumination device 2 includes a control module 21, a connection module 22, a light emitting diode module 23, a first signal transmitting and receiving module 25, and a second signal transmitting and receiving module 26. The control module 21 includes a first fixing unit 211. The control module 21 is detachably disposed on a fixing base 20 by the first fixing unit 211. The fixing base 20 is installed on a ceiling or a wall in the room. The control module 21 is disposed in a housing (not shown). In the embodiment, the fixing base 20 and the housing (not shown) of the control module 21 is made of plastic, but is not limited thereto in the present disclosure.

The first signal transmitting and receiving module 25 and the second signal transmitting and receiving module 26 are connected to the control module 21. The control module 11 is electrically connected to a control system (not shown). In the embodiment, each of the first signal transmitting and receiving module 25 and the second signal transmitting and receiving module 26 is a Bluetooth to serial control signal conversion module. In other words, the first signal transmitting and receiving module 25 and the second signal transmitting and receiving module 26 can receive a Bluetooth control signal and convert the Bluetooth control signal into a serial control signal, and the serial control signal is a wired communication signal. The first signal transmitting and receiving module 25 and the second signal transmitting and receiving module 26 also convert the serial control signal transmitted from control system through the control module 21 into a Bluetooth control signal and transmit the Bluetooth control signal to a mobile device (not shown) or an electronic device (not shown) for executing a control process.

The light emitting diode module 23 include a plurality of light emitting diode units 231 and a substrate 232. The light emitting diode units 231 are disposed on the substrate 232. The light emitting diode module 23 is electrically connected to the control module 21. The control module 21 controls a turn-on state, a turn-off state, a brightness value, colors, or a lighting mode of the light emitting diode module 23 based on a lighting control signal of the control system (not shown).

In the embodiment, the light emitting diode module 23 is disposed on one side of the control module 11. Since the fixing base 20 is disposed on the ceiling, the light emitting diode module 23 is disposed below the control module 21.

The connection module 22 is disposed at an exterior of the control module 21. The connection module 22 includes a receiving unit 223, a first connection unit 225, and a second connection unit 226. One end of the first connection unit 225 and one end of the second connection unit 226 are respectively fixed on two sides of the receiving unit 223. The first signal transmitting and receiving module 25 is disposed at another end of the first connection unit 225. The second signal transmitting and receiving module 26 is disposed at another end of the second connection unit 226.

In the embodiment, the first signal transmitting and receiving module 25 and the second signal transmitting and receiving module 26 are electrically connected to the control module 21 by a connection cable (not shown), respectively. In other words, the connection cable (not shown) between the first signal transmitting and receiving module 25 and the control module 21, and the connection cable (not shown) between the second signal transmitting and receiving module 26 and the control module 21 are respectively disposed in the first connection unit 225 and the second connection unit 226. The control module 21 provides a driving power to the first signal transmitting and receiving module 25 and the second signal transmitting and receiving module 26 by the connection cables (not shown). In other embodiments, the first signal transmitting and receiving module 25 and the second signal transmitting and receiving module 26 wirelessly communicate with the control module 21, but are not limited thereto in the present disclosure.

The receiving unit 223 is disposed at the exterior the control module 21, and is formed by two extension portions 2231, 2232 extending from the upper side and lower side of the housing of the control module 21.

In the embodiment, the extension portions 2231, 2232 of the upper side and the lower side of the connection module 223 do not include a retaining wall, and an accommodation space is defined by the two extension portions 2231, 2232. The first connection unit 225 and the second connection unit 226 are disposed in the accommodation space of the receiving unit 223. Each of the first connection unit 225 and the second connection unit 226 is a foldable connection unit. Each of the first connection unit 225 and the second connection unit 226 includes a plurality of connection portions. Each of the first connection unit 225 and the second connection unit 226 includes four connection portions. The first connection unit 225 includes a first connection portion 225A, a second connection portion 225B, a third connection portion 225C, and a fourth connection portion 225D. The second connection unit 226 includes a first connection portion 226A, a second connection portion 226B, a third connection portion 226C, and a fourth connection portion 226D.

The first connection portions 225A and 226A are fixedly disposed at an inside of the receiving unit 223. The second connection portion 225B is connected to the first connection portion 225A. The third connection portion 225C is connected to the second connection portion 225B. The fourth connection portion 225D is connected to the third connection portion 225C. The four connection portions of the first connection unit 225 are sequentially connected. The second connection portion 226B is connected to the first connection portion 226A. The third connection portion 226C is connected to the second connection portion 226B. The fourth connection portion 226D is connected to the third connection portion 226C. The four connection portions of the second connection unit 226 are sequentially connected. The first signal transmitting and receiving module 25 is disposed on the fourth connection portion 225D of the first connection unit 225. The second signal transmitting and receiving module 26 is disposed on the fourth connection portion 226D of the second connection unit 226.

Referring to FIG. 5 and FIG. 6, each of the four connection portions of the first connection unit 25 is disposed in the upper side of the receiving unit 223. Each of the second connection unit 26 is disposed in the lower side of the receiving unit 223. In other words, each of the connection portions of the first connection unit 25 and the second connection unit 26 is a quarter of an annular area of the receiving unit 223. Furthermore, since the first connection unit 25 and the second connection unit 26 are foldable, a user can adjust unfolded lengths of the first connection unit 25 and the second connection unit 26 based on a radius D1 or a radius D3 of the light emitting diode module 23. A more appropriate configuration would be to dispose the first signal transmitting and receiving module 25 and the second signal transmitting and receiving module 26 on an edge of the light emitting diode module 23 for transmitting or receiving the signals.

In the embodiment, the light emitting diode module 23 further includes a second fixing unit 233. The light emitting diode module 23 is detachably fixed on one side of the control module 21 through the second fixing unit 233. In other words, the light emitting diode module 23 is disposed below the first signal transmitting module 25 and the second signal transmitting module 26. In other words, the light emitting diode module 23, the first signal transmitting module 25, and the second signal transmitting module 26 are disposed on different planes. The light emitting diode module 23 is electrically connected to the control module 21 through the second fixing unit 233.

In addition, one of the light emitting diode illumination devices 1, 2 of the present disclosure can be in communication with the other of the light emitting diode illumination devices 1, 2 by a wired communication. In other words, the control modules of the plurality of light emitting diode lighting devices 1 and 2 can be in communication with each other by a wired communication.

### Third Embodiment

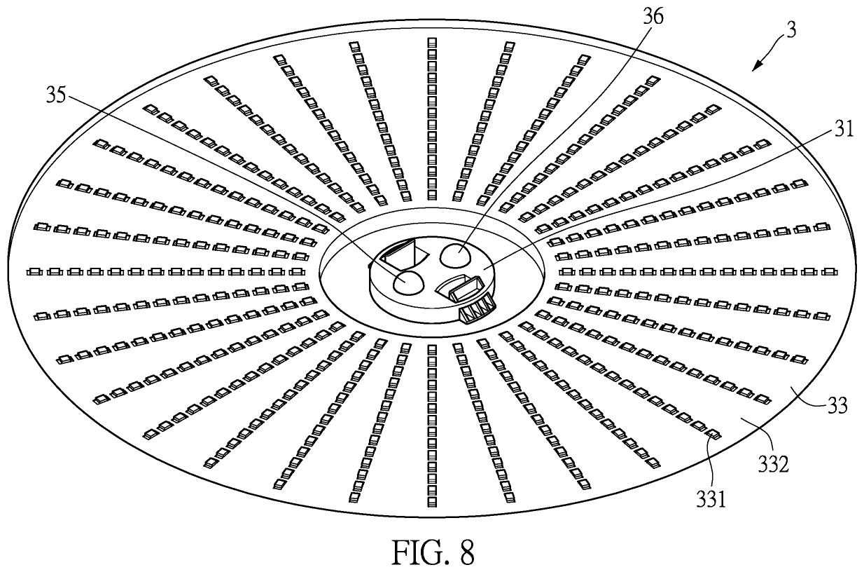

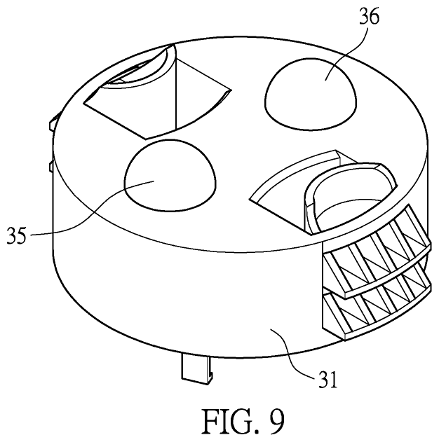

Referring to FIG. 8 and FIG. 9, FIG. 8 is a schematic view of a light emitting diode illumination device of a third embodiment of the present disclosure. FIG. 9 is a schematic view of a control module and a signal transmitting and receiving module in FIG. 8.

A light emitting diode illumination device 3 of this embodiment is similar to the light emitting diode illumination device 1 and the light emitting diode illumination device 2 of the previous embodiments. The greatest difference is that two signal transmission modules 35 of the embodiment are provided on one side of the control module 31, and the light emitting diode module 33 is provided around the control module 31.

In the embodiment, the light emitting diode module 33 is disposed around the control module 31. As shown in FIG. 8, a central area of the light emitting diode module 33 has an opening for receiving the control module 31. The first signal transmitting and receiving module 35, the second signal transmitting and receiving module 36, and the light emitting diode module 33 are disposed at a same plane for receiving the signals.

However, the second fixing unit (not shown) of the light emitting diode module 33 is not disposed in the central area, but is not limited thereto in the present disclosure. In addition, the light emitting diode module 33 is fixed on the fixing base 30 through a second fixing unit, and is electrically connected to the control module 31. As shown in FIG. 8, the plurality of light emitting diode units 332 of the light emitting diode module 33 are radially disposed on the substrate 331. In addition, any of the light emitting diode illumination devices 1, 2, 3 of the present disclosure can be in communication with another of the light emitting diode illumination devices 1, 2, 3 by a wired communication. In other words, the control modules of the plurality of light emitting diode illumination devices 1, 2, 3 can be in communication with each other by a wired communication.

In conclusion, the light emitting diode illumination device provided by the present disclosure has a detachable and stackable structure. Each of components of the light emitting diode illumination device is modularized, and the design of the illumination device can be easily adjusted based on the user's requirement. Therefore, an installation cost is effectively reduced.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A light emitting diode illumination device comprising:
a control module including a first fixing unit, the first fixing unit being detachably fixed on a fixing base;
a signal transmitting and receiving module being connected to the control module; and
a light emitting diode module including a plurality of light emitting diode units and a substrate, the light emitting diode units being disposed on the substrate, the light emitting diode module being electrically connected to the control module;
wherein the light emitting diode module is disposed at one side of the control module.

2. The light emitting diode illumination device of claim 1, wherein the signal transmitting and receiving module is connected to the control module by a connection module.

3. The light emitting diode illumination device of claim 2, wherein the connection module includes a connection cable.

4. The light emitting diode illumination device of claim 2, wherein the connection module further includes a receiving unit disposed around the control module.

5. The light emitting diode illumination device of claim 4, wherein the connection module includes a connection port, the connection port is electrically connected to the control module and the connection cable, and the connection cable is disposed in an accommodation space of the receiving unit.

6. The light emitting diode illumination device of claim 4, wherein the connection module further includes at least one foldable connection unit, the connection cable is disposed in the at least one foldable connection unit, and the at least one foldable connection unit is foldable and disposed in the receiving unit.

7. The light emitting diode illumination device of claim 1, wherein the light emitting diode module includes a second fixing unit, the light emitting diode module is disposed around the control module, and the light emitting diode module and the signal transmitting and receiving module are disposed at a same plane.

8. The light emitting diode illumination device of claim 1, wherein the light emitting diode module and the signal transmitting and receiving module are disposed at different planes.

9. The light emitting diode illumination device of claim 1, wherein the light emitting diode module includes a second fixing unit, and the light emitting diode module is detachably fixed on the fixing base through the second fixing unit.

10. The light emitting diode illumination device of claim 1, wherein the light emitting diode illumination device being in communication with another light emitting diode illumination device by a wired communication.
